(19) United States
(12) Patent Application Publication
(10) Pub. No.: US 2025/0121296 A1
(43) Pub. Date: Apr. 17, 2025

(54) SYSTEMS AND METHODS FOR RESETTING A SHOW EFFECT SYSTEM

(71) Applicant: Universal City Studios LLC, Universal City, CA (US)

(72) Inventors: Morris A. VanKerschaever, Orlando, FL (US); Blaine Michael Gathman, Altamonte Springs, FL (US); David Gerard Majdali, Orlando, FL (US)

(21) Appl. No.: 18/759,207

(22) Filed: Jun. 28, 2024

Related U.S. Application Data
(60) Provisional application No. 63/590,978, filed on Oct. 17, 2023.

(51) Int. Cl. A63G 31/00; H01R 13/633; H01R 13/70

(52) U.S. Cl. CPC A63G 31/00; H01R 13/633; H01R 13/701

(57) ABSTRACT

A show effect system may include one or more cables, a front panel coupled to one or more coupling joints configured to receive the one or more cables and provide a signal indicative of a connection between a first cable of the one or more cables and a first coupling joint of the one or more coupling joints, and a slidable plate coupled to one or more pins and an actuator, wherein the actuator is configured to drive the slidable plate to bring a first pin of the one or more pins into contact with the first cable to disconnect the first cable from the first coupling joint.

### CROSS-REFERENCE TO RELATED APPLICATIONS

This application claims priority to U.S. Provisional Application No. 63/590,978, entitled “SYSTEMS AND METHODS FOR RESETTING A SHOW EFFECT SYSTEM,” filed Oct. 17, 2023, which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Special effects can be used throughout amusement parks and other entertainment venues to help immerse guests in an experience of an attraction (e.g., ride, show). For example, show components may include three-dimensional (3D) props and set pieces, mechanical elements, electrical elements, and/or display surfaces that present virtual interactive elements. In some cases, the guests may interact with the show components to provide or generate the special effects. It is presently recognized that it may be desirable for the entertainment venues to provide creative methods of entertaining the guests, such as creative methods of presenting the show components.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a show effect system may include one or more cables, a front panel coupled to one or more coupling joints configured to receive the one or more cables and provide a signal indicative of a connection between a first cable of the one or more cables and a first coupling joint of the one or more coupling joints, and a slidable plate coupled to one or more pins and an actuator, wherein the actuator is configured to drive the slidable plate to bring a first pin of the one or more pins into contact with the first cable to disconnect the first cable from the first coupling joint.

In an embodiment, a connector assembly may include a slidable plate coupled to one or more pins, a mounting plate configured to couple to a front panel of a show effect system, wherein the front panel comprises one or more coupling joints configured to receive one or more cables, and an actuator configured to drive the slidable plate relative to the mounting plate from a first position to a second position to cause the one or more pins to contact and eject the one or more cables received by the one or more coupling joints.

In an embodiment, a show effect system may include a guest tracking system configured to generate data indicative of a guest position and one or more coupling joints, wherein each coupling joint of the one or more coupling joints is configured to receive a respective cable of the one or more cables and provide a respective signal indicative of a respective connection to the respective cable of the one or more cables. The show effect system may also include one or more pins configured to contact the one or more cables to disconnect the one or more cables from the one or more coupling joints and an actuator configured to adjust the one or more pins from a first position to a second position to cause the one or more pins to contact the one or more cables to disconnect of the one or more cables from the one or more coupling joints. The show effect system may also include a controller communicatively coupled to the guest tracking system, the one or more coupling joints, and the actuator, where the controller is configured to receive the data indicative of the guest position and instruct the actuator to adjust the one or more pins from the first position to the second position based on the guest position.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of an attraction system that may be used in an amusement park or entertainment venue, in accordance with an aspect of the present disclosure;

FIG. 2 is a perspective view of an embodiment of a show effect system that may be used in the attraction system of FIG. 1, in accordance with an aspect of the present disclosure;

FIG. 3 is a flowchart of an embodiment of a process for operating the show effect system of FIG. 2, in accordance with an aspect of the present disclosure;

FIG. 4 is a top perspective view of an embodiment of a connector assembly that may be used in the show effect system of FIG. 2, in accordance with an aspect of the present disclosure;

FIG. 5 is a perspective view of an embodiment of the connector assembly that may be used in the show effect system of FIG. 2, in accordance with an aspect of the present disclosure;

FIG. 6 is a partially exploded view of an embodiment of the connector assembly that may be used in the show effect system of FIG. 2, in accordance with an aspect of the present disclosure;

FIG. 7 is a flowchart of an embodiment of a process for generating show effects via the show effect system of FIG. 2, in accordance with an aspect of the present disclosure;

FIG. 8 is a top cross-sectional view of an embodiment of a portion of the connector assembly that may be used in the show effect system of FIG. 2, in accordance with an aspect of the present disclosure;

FIG. 9 is a top perspective view of an embodiment of a portion of the connector assembly of FIG. 2, in accordance with an aspect of the present disclosure; and

FIG. 10 is a schematic illustration of operating an embodiment of the connector assembly that may be used in the show effect system of FIG. 2, in accordance with an aspect of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure is directed to providing and/or facilitating show effects for entertainment purposes. For example, present embodiments may be employed to provide and/or facilitate the show effects to entertain guests in an entertainment venue. The entertainment venue may include any of a variety of attractions, such as one or more rides (e.g., a roller coaster), one or more theatrical shows, one or more set designs, one or more performers, one or more escape rooms, and/or one or more decoration elements, to entertain the guests. The present embodiments may supplement or complement the attractions, such as by providing for guest interactions (e.g., input) and generating show effects. For example, the show effects may be presented along with the attractions to provide an interactive experience for the guests.

With the foregoing in mind, the entertainment venue may include an attraction portion with a show effect system that provides for guest interactions and/or generates show effects. In an embodiment, the guests may receive an assignment upon entering the attraction portion and interact with the show effect system to complete the assignment. For example, the show effect system may include an interactive component with one or more elements for guest interactions, and the assignment may include arranging elements of the interactive component based on a pattern. For example, the guest interactions may include adjusting a position and/or the orientation of the elements in relation to the interactive component. If the guest interactions match the pattern of the elements (e.g., wherein the pattern of elements is stored in and accessed from a database), the show effect system may generate a show effect, such as a visual and/or audio effect to indicate a completed assignment to the guests.

The entertainment venue may also include one or more attraction portions (e.g., rooms) that each provides for guest interactions and/or generation of show effects. The guests may travel between the rooms in order to experience the attraction portions. For example, a first guest may enter a first attraction portion and interact with the show effect system, and after a period of time, leave the first attraction portion to travel to a second attraction portion. Due to the guest interactions by the first guest with the show effect system, the position and/or the orientation of the elements in relation to the interactive component of the show effect system may be in a coupled (e.g., connected; in contact; engaged) configuration. Prior to additional guest interactions, the show effect system may be reset to a decoupled (e.g., disconnected; separated; disengaged) configuration. To this end, without the embodiments disclosed herein, an operator may enter to the first attraction portion to manually reset the show effect system back to the decoupled configuration, and exit the room prior to additional guest interactions. However, it is presently recognized that manually resetting the show effect system takes time, which may decrease guest throughput and operation efficiency.

Thus, it is presently recognized that decreasing an amount of time spent resetting the show effect system may improve operation efficiency of the entertainment venue. For example, it may be desirable to automate the process of resetting the show effect system from a coupled configuration after guest interactions to a decoupled configuration prior to additional guest interactions. Accordingly, embodiments of the present disclosure are directed to a show effect system with a connector assembly with interactive components that provide for guest interactions and ejector components that provide for resetting the show effect system after the guest interactions. For example, the show effect system may be in the coupled configuration during and/or after guest interactions and reset to the decoupled configuration prior to additional guest interactions. Additionally or alternatively, embodiments of the present disclosure monitor guest positions within the attraction portion and reset the show effect system based on the guest positions. For example, the attraction portion may include a guest tracking system that monitors the guest positions within the attraction portion, and a controller that receives the guest positions from the guest tracking system. The controller may instruct the ejector components to reset the show effect system based on an indication from the guest tracking system that the attraction portion that contains or is associated with the show effect system does not include any guests. In this way, the show effect system may efficiently reset the show effect system for guest interactions without operator interactions.

While the illustrated examples include resetting the show effect system within the entertainment venue, embodiments of the present disclosure may also be implemented for resetting a testing board, an educational board, a game, and/or a mechanical display in any of a variety of entertainment venues and/or other types of venues (e.g., sports arenas, zoos, museums, schools, restaurants, hotels). For example, an educational board may include a connector assembly with interactive components, such as wires, cables, pins, and/or fasteners, for a user to connect to the educational board. The educational board may also include ejector components for ejecting connected wires, cables, pins, and/or fasteners from the educational board to reset the educational board. As such, the educational board may be in the coupled configuration due to user interactions, and then, reset to the decoupled configuration after the user interactions. In this way, the educational board may reset without additional user interactions, thereby improving the operational efficiency of the educational board.

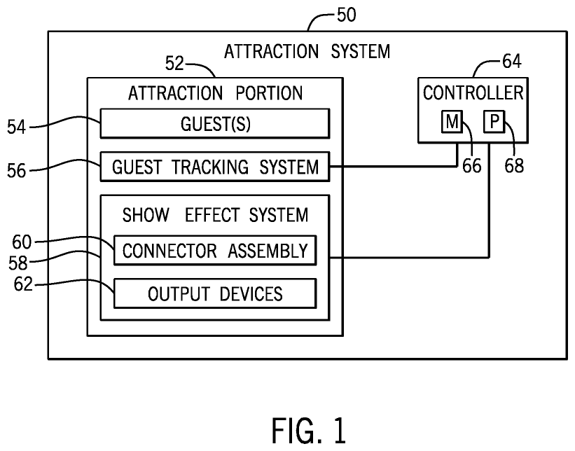

With the preceding in mind, FIG. 1 is a block diagram of an embodiment of an attraction system 50 that may be used in an entertainment venue and/or other venue. As an example, the attraction system 50 may include an attraction portion 52 that may provide entertainment to guests 54. The attraction portion 52 may include a ride (e.g., a dark ride), a haunted house, an escape room, a theater, a maze, and/or the like. For example, the attraction portion 52 may include an escape room attraction that may include one or more rooms (e.g., portions) that provide guest interactions, and may also include one or more pathways for the guests 54 to travel through the one or more rooms and/or the attraction portion 52. By way of example, the guests 54 may enter a first room, interact with the first room, then travel to a second room, for example, via a pathway. In certain instances, the one or more rooms may each include one or more doors (e.g., for entry into and/or exit out of the one or more rooms). For example, the attraction portion 52 may include multiple rooms that are proximate to each other, such that the guests 54 may travel between the multiple rooms via a door(s) and/or a pathway.

The attraction portion 52 may include a guest tracking system 56 to monitor guest position within the attraction portion 52 (e.g., the one or more rooms). For example, the guest tracking system 56 may collect and/or generate data indicative of guest presence in a first room of the attraction portion 52 and/or data indicative of a lack of guest presence in a second room. To this end, the guest tracking system 56 may include one or more sensors that collect and/or generate the data indicative of the guest position, and the data may be processed and/or analyzed to determine the guest position of the guests 54. The guest tracking system 56 may monitor the position of one guest within the attraction portion 52 and/or multiple guests within the attraction portion 52. For example, the guest tracking system 56 may generate image data of a room that may be analyzed to determine guest presence of one guest and/or multiple guests, guest position of one guest and/or multiple guests, a configuration of the show effect system 58, and so on. For example, the one or more sensors may include a camera (e.g., optical camera, three-dimensional (3D) camera, infrared (IR) camera, depth-based camera), a position sensor (e.g., sonar sensor, radar sensor, laser imaging, detection, and ranging (LIDAR) sensor), time of flight sensor, communication device (e.g., radiofrequency communication to communicate with guest devices carried by the guests), and/or the like. The one or more sensors may generate sensor data (e.g., video data) indicative of the guests 54 (e.g., in the IR spectrum, which may not be visible to the guests 54) being present within the first room (or another room and/or a pathway). In another example, the one or more sensors may be a pressure sensor and/or a proximity sensor that generates sensor data indicative of the guests 54 being present within the first room (or another room and/or a pathway). Additionally or alternatively, the guest tracking system 56 may utilize and/or generate interaction data due to the guest interactions within the attraction portion 52 to determine the guest position of the guests 54.

The attraction portion 52 may include a show effect system 58 that receives guest interactions (e.g., inputs) and/or generates a show effect for guest entertainment. To this end, the show effect system 58 may include a connector assembly 60 to facilitate the guest interactions and/or one or more output devices 62 to generate the show effect. The connector assembly 60 may include one or more interactive components that enable and/or provide for the guest interactions. For example, the one or more interactive components may include one or more wires, such as cables (e.g., audio cables or cords; one or more wires arranged within a sheath to form a cable), positioned proximate to an exterior surface of the show effect system 58. The one or more interactive components may also include one or more coupling joints coupled to the exterior surface. To facilitate discussion, the one or more wires are also referred to as “a cable” or “cables” herein.

Each of the cables may include a metal connector (e.g., male phono plug), and each of the coupling joints may include a socket (e.g., audio jacks; audio ports) that receives the metal connector. During the guest interactions, the guests 54 transition the show effect system 58 from a decoupled configuration to a coupled configuration by coupling a connector of a first cable to a first coupling joint and coupling a connector of a second cable to a second coupling joint. By coupling the one or more cables to the one or more coupling joints, the show effect system may generate an electrical signal that may be used (e.g., by a controller 64) to determine if the connections in the coupled configuration match a connection pattern stored in a database and/or a memory (e.g., a memory 66 of a controller 64). It should be appreciated that reference to coupling the one or more cables to the one or more coupling joints herein refers to coupling the respective connectors of the one or more cables to the respective sockets of the one or more coupling joints.

The show effect system may include one or more output devices 62 to provide one or more clues and/or the show effect to the guests 54. To this end, the one or more output devices 62 may include a light source (e.g., strobe light, a light-emitting diode (LED), an organic light-emitting diode (OLED), a flashlight), a display (e.g., liquid crystal display (LCD), light emitting diode (LED) display, organic light emitting diode (OLED) display, micro-LED, a projector), a sound source (e.g., speakers), and/or the like. For example, the one or more output devices 62 may include visual and/or audio clues indicative of the connection pattern for the one or more cables and/or coupling joints. In an embodiment, the one or more output devices 62 may output musical notes in a pattern indicative of the connection pattern to provide an audio clue of the connection pattern to the guests 54. In an embodiment, the one or more output devices 62 may display a string of letters and/or shapes to provide a visual clue to the guests 54.

Additionally or alternatively, the one or more output devices 62 may generate the show effect to provide entertainment to the guests 54. For example, the one or more output devices 62 may generate the show effect if the connections in the coupled configuration (e.g., guest interactions) match the connection pattern. As further described herein, the connection pattern may be stored in a database and/or a memory, such as within the memory 66 of the controller 64, and may include target connections between the one or more cables and the one or more coupling joints. The one or more output devices 62 may generate show effects, such as one or more visual and/or audio effects, in response to the guest interactions matching the connection pattern. For example, the one or more output devices 62 may be a strobe light that flashes a light to provide a visual indication to the guest 54 of the connections in the coupled configuration matching the connection pattern. In another example, the one or more output devices 62 may emit a song corresponding to one or more objects (e.g., animated characters, vehicles, instruments) within the attraction portion 52. In this way, the guests 54 may receive an indication that the connections between the one or more cables and the one or more coupling joints match connections of a connection pattern. In certain instances, the one or more output devices 62 may generate the show effect in response to a lapse of a period of time. For example, the show effects may be used to indicate to the guests 54 that the period of time allocated for interacting with the show effect system 58 and/or the room may expire and the guests 54 may travel to a different room of the attraction portion 52. Although the one or more output devices 62 are illustrated within the show effect system 58, at least a portion of the one or more output devices 62 may be located within the attraction portion 52 and/or outside of the show effect system 58.

After the guests 54 leave a vicinity of the show effect system 58 (e.g., exit through a door and/or from the room with the show effect system 58; after closure of the door; while all doors to the room with the show effect system 58 are closed so as to block access to and/or separate the room from all of the guests 54), the show effect system 58 may transition from the coupled configuration to a decoupled configuration to prepare for additional guest interactions. For example, the show effect system 58 may eject (e.g., push out) the one or more connectors of the one or more cables from the one or more sockets of the one or more coupling joints without operator interference. In the decoupled configuration, the one or more connectors of the one or more cables may not be coupled to the one or more sockets of the one or more coupling joints. As such, the show effect system 58 may prepare for additional guest interactions without operator input.

To this end, the connector assembly 60 may include one or more ejector components. In one embodiment, the one or more ejector components may include a support, such as a slidable plate, a chassis, or a bracket. To facilitate discussion, the support may be referred to herein as “a slidable plate.” The one or more ejector components may also include one or more pins coupled to the slidable plate, and one or more actuators that adjust a position of the slidable plate and/or the one or more pins. Each of the one or more pins may include a head (e.g., flat head) that contacts with a respective connector of a respective cable and a stem that may be mounted (e.g., fixedly coupled) to the slidable plate. For example, the one or more pins may each be a stainless steel socket head screw. The one or more actuators may include a linear actuator, a cammed mechanical device, a pneumatic actuator, a rotary actuator, and/or the like. In an embodiment, one actuator may be coupled to one pin, and the actuator may adjust a position of the pin by rotating, orienting, and/or linearly translating the pin between a first position and a second position. In the first position, the pin may be positioned proximate to a respective connector of a respective cable. In the second position, the pin may contact and eject the respective connector of the respective cable from a respective coupling joint of the one or more coupling joints.

In an embodiment, one actuator may be coupled to multiple pins via the slidable plate, and the actuator may adjust the position of the multiple pins to simultaneously move the multiple pins between the first position and the second position. For example, the one or more actuators may be coupled to the slidable plate, and the one or more actuators may drive the slidable plate to adjust the position and/or the orientation of the one or more pins to simultaneously move the one or more pins between the first position and the second position. In this way, the show effect system 58 may be reset to the decoupled configuration after the guest interactions and/or to prepare for additional guest interactions. Additionally or alternatively, the show effect system 58 may provide a visual clue to the guests 54 that a connection between a respective connector and a respective coupling joint formed by the guests 54 does not match the connection pattern. For example, the guests 54 may incorrectly couple one connector of one cable to an incorrect coupling joint with respect to the connection pattern. In response to detecting the incorrect connection by the guests 54, the one or more actuators may be instructed to actuate to adjust the position and/or the orientation of a respective pin to eject the one connector from the incorrect coupling joint that forms the incorrect connection pattern. In another example, in response to detecting the incorrect connection pattern, the one or more actuators may be instructed to actuate to adjust the position of all pins to eject all connectors from respective coupling joints. In another example, a quantity of incorrect connections may be counted and compared to a threshold quantity. Then, in response to the quantity of incorrect connections meeting or exceeding the threshold quantity, the one or more actuators may be instructed to actuate to adjust the position of one or more pins to eject at least one and/or all connectors from respective coupling joints. For example, if two, three, four, or more of the connections between the connectors and the coupling joints do not correspond to the connections within the connection pattern, the one or more actuators may cause ejection of at least one and/or all coupled cables (e.g., break all of the connections) to provide the visual indication to the guests 54 of the incorrect connections.

The attraction system 50 may also include or coordinate with a controller 64 (e.g., a control system, an automated controller, a programmable controller, an electronic controller, control circuitry, a cloud-computing system) configured to operate the show effect system 58 to provide the interactive experience to the guest(s) 54. For example, the controller 64 may be communicatively coupled (e.g., via one or more cables, via wireless communication (e.g., via transmitters, receivers, transceivers)) to the guest tracking system 56 and/or the show effect system 58.

The controller 64 may include a memory 66 (representative of one or more memories) and processing circuitry or a processor 68 (representative of one or more processors). The memory 66 may include volatile memory, such as random-access memory (RAM), and/or non-volatile memory, such as read-only memory (ROM), optical drives, hard disc drives, solid-state drives, or any other non-transitory computer-readable medium that may include instructions to operate the show effect system 58. The memory 66 may also store information and/or data. For example, the memory 66 may store a connection pattern with target (e.g., correct) connections between each of the connectors and a respective coupling joint that causes the show effect system 58 to output and/or to provide the show effect.

The processor 68 may be configured to execute the instructions stored in the memory 66. For example, the processor 68 may include one or more application specific integrated circuit(s) (ASICs), one or more field programmable gate array(s) (FPGAs), one or more general purpose processor(s), or any combination thereof. In certain instances, the controller 64 may include one or more controller(s) that are communicatively coupled and may individually or collectively perform actions described herein. Additionally or alternatively, the controller 64 may include one or more processor(s) 68 and/or one or more memories 66 that may individually or collectively perform the actions described herein (e.g., the actions may be distributed between multiple processors; one processor may perform certain actions, another processor may perform other actions, and so forth).

The controller 64 may receive data (e.g., sensor data) from the guest tracking system 56, wherein the data is indicative of the position of the guests 54 within the attraction portion 52 and/or a presence of the guests 54 within a room of the attraction portion 52. For example, the data may be indicative of a first group of guests 54 positioned in and/or present within a first room of the attraction portion 52 and a second group of guests positioned in and/or present within a second room of the attraction portion 52. After a period of time (e.g., the lapse of the period of time), the data may be indicative of the first group of guests 54 leaving the first room and traveling to the second room and the second group of guests 54 leaving the second room and traveling to a third room within the attraction portion 52. In another example, the data may be indicative of the first group of guests 54 waiting to enter the first room and a second group of guests 54 traveling from the first room to the second room. As described herein, the data may be utilized to reset the show effects system 58 at particular times (e.g., without any of the guests 54 in the room that contains the show effect system 58).

When the guests 54 approach the show effect system 58 within the attraction portion 52 (e.g., enter the room with the show effect system 58), the controller 64 may instruct the one or more output devices 62 to provide one or more visual and/or audio clues indicative of the connection pattern to the guests 54. For example, the controller 64 may transmit image data to the one or more output devices 62 and instruct the one or more output devices 62 to display the image data. The image data may include a string of text, letters, numbers, symbols, representations, or any combination thereof to provide a visual clue to the guests 54 of the connection pattern. Additionally or alternatively, the controller 64 may instruct the one or more output devices 62 to output an audio pattern, such as musical notes for the guests 54 to provide an audio clue to the guests 54 of the connection pattern. During the guest interactions, the controller 64 may receive data (e.g., signal) from the connector assembly 60 of one or more cables mated with respective coupling joints) formed by the guests 54. For example, the connector assembly 60 may provide a signal (e.g., voltage value, current value, impedance) when the guests 54 connect a respective connector of a cable of the one or more cables to a respective coupling joint of the one or more coupling joints. Based on the signal, the controller 64 may determine if the connection between the respective connector and the coupling joint matches a connection of the connection pattern. Additionally or alternatively, the controller 64 may receive data from the guest tracking system 56 indicative of the connection. For example, the guest tracking system 56 may include a camera within the attraction portion 52 that may also generate data indicative of the guests 54 connecting the particular cable to the respective coupling joint. That is, the data may be indicative of a position of the particular cable with respect to the respective coupling joint.

When the guest interactions (e.g., the coupled cable(s) mated with respective coupling joint(s)) match the connection pattern (e.g., a correct connection pattern), the controller 64 may instruct the one or more output devices 62 to generate the show effect. For example, the controller 64 may instruct the one or more output devices 62 to flash a light, output a sound and/or a song, display image data, and/or the like. When the guest interactions do not match the pattern (e.g., the incorrect connection pattern), the controller 64 may instruct the connector assembly 60 to provide the visual indication to the guests 54. For example, the controller 64 may instruct the ejection components to adjust the position and/or the orientation of the one or more pins. That is, the controller 64 may instruct the one or more actuators to adjust the position and/or the orientation of the one or more pins such that all or some of the coupled cables may be decoupled from the respective coupling joint(s) of the one or more coupling joints. In this way, the show effect system 58 may provide an interactive and/or immersive experience for the guests 54.

Due to the guest interactions, the show effect system 58 may be in the coupled configuration. To prepare for subsequent guest interactions, the controller 64 may instruct the show effect system 58 to transition from the coupled configuration to the decoupled configuration. For example, the controller 64 may receive data from the guest tracking system 56 indicative of the guests 54 leaving a first room with the show effect system 58 and/or entering a second room. The controller 64 may instruct the show effect system 58 to transition from the coupled configuration to the decoupled configuration based on the data indicative of the guests 54 leaving the first room and/or entering the second room. Additionally or alternatively, the controller 64 may instruct the show effect system 58 to transition to the decoupled configuration based on the data being indicative of no guest presence within the first room. For example, the controller 64 may instruct the ejector components to decouple any connectors from respective coupling joints. The controller 64 may instruct the one or more actuators to decouple (e.g., disconnect, eject) one or more coupled cables from respective coupling joints. The one or more actuators may adjust the position and/or the orientation of the one or more pins and/or the position of the slidable plate to decouple the one or more coupled cables from respective coupling joints. In this way, the show effect system 58 may be reset without operator input, thereby reducing an amount of time used to reset the show effect system 58 and increasing guest throughput.

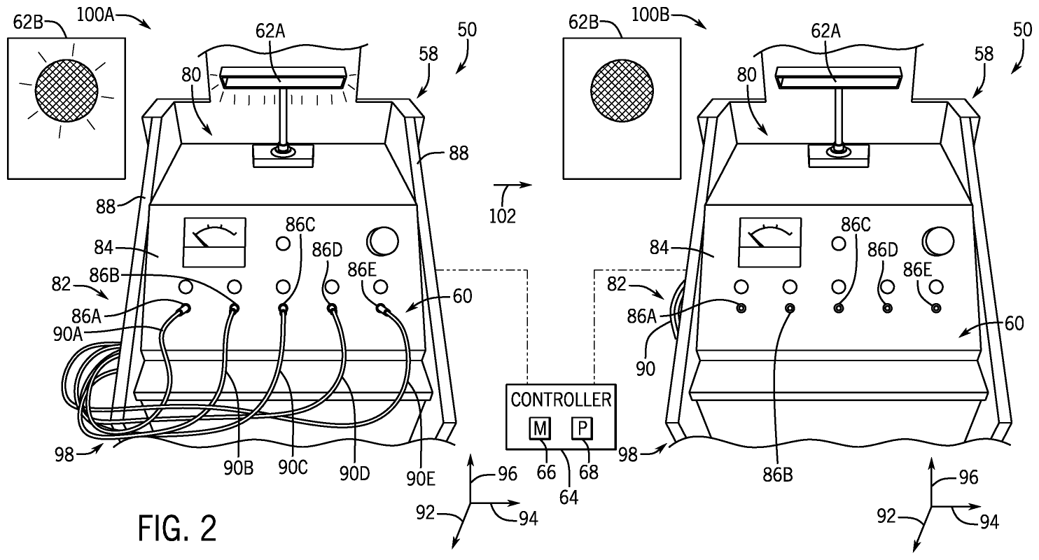

FIG. 2 is a perspective view of an embodiment of the show effect system 58 that may be used in the attraction system 50. The show effect system 58 may include an enclosure 80 (e.g., representative of multiple enclosures coupled to one another, or representative of a single enclosure; housing). The enclosure 80 may define a first volume 82 (e.g., area, region, portion) with the connector assembly 60. In particular, the first volume 82 may include a front plate 84 coupled to and/or supporting one or more coupling joints 86 of the connector assembly 60. The first volume 82 may also include two side panels 88 proximate to and/or supporting one or more cables 90 of the connector assembly 60. The front plate 84 may be positioned to face in a longitudinal direction 92 with respect to the show effect system 58, the two side panels 88 may be positioned to face in a lateral direction 94, and the one or more output devices 62 may be positioned proximate to (e.g., above or below) the first volume 82 relative to a vertical direction 96. The show effect system 58 may include the one or more cables 90 positioned proximate to a respective side panel 88. The one or more cables 90 may include a length to extend from the respective side panel 88 of the show effect system 58 to the front plate 84. As such, the guests 54 may couple one or more cables 90 to a respective coupling joint 86 via a respective connector of the respective cable 90. In this way, the show effect system 58 may provide and/or enable guest interactions via the one or more cables 90 and the one or more coupling joints 86, which operate as interactive components.

The enclosure 80 may also define a second volume 98 (e.g., area, region, portion) in which the controller 64 may be positioned. However, in an embodiment, the controller 64 may be external to the enclosure 80 and/or may communicate wirelessly with other aspects of the show effect system 58. The enclosure 80 may include various features, such as walls, panels, and barriers, that may shield components of the show effect system 58 (e.g., the one or more coupling joints 86, the slidable plate, the one or more actuators, the one or more pins) from being detected by the guests 54 and/or from contact with various external elements, such as dust and debris. As such, the enclosure 80 may protect such components to enable the desirable operation and/or prolong the useful lifespan of the show effect system 58. In additional or alternative embodiments, the enclosure 80 may include features, such as doors, that may enable access to a component, such as the controller 64, disposed within the enclosure 80. In this way, the enclosure 80 may enable various operations, such as an inspection operation, a maintenance operation, a repair operation, and/or a replacement operation, to be performed with respect to the component, while also providing shielding capabilities for the show effect system 58.

The guests 54 may couple the one or more cables 90 to respective coupling joints 86 based on one or more audio and/or visual effects (e.g., clues). As illustrated, in the coupled configuration 100A, the show effect system 58 may include each of the one or more cables 90 coupled to a respective coupling joint 86. As illustrated, the show effect system 58 may include a first coupling joint 86A coupled to a first cable 90A, a second coupling joint 86B coupled to a second cable 90B, a third coupling joint 86C coupled to a third cable 90C, a fourth coupling joint 86D coupled to a fourth cable 90D, and fifth connection point 86E coupled to a fifth cable 90E. Although not illustrated, it may be understood that each cable 90 includes a connector (e.g., metal connector) that couples to a respective coupling joint 86, thereby coupling the cable 90 to the coupling joint 86. While the illustrated show effect system 58 includes five cables and five coupling joints, the show effect system 58 may include any suitable quantity of cables and/or coupling joints, such as two or more cables and/or coupling joints, three or more cables and/or coupling joints, four or more cables and/or coupling joints, six or more cables and/or coupling joints, seven or more cables and/or coupling joints, and so on. The show effect system 58 may also include differing quantity of cables and coupling joints, such as more cables than coupling joints, or more coupling joints than cables.

By way of illustrative example, each of the one or more cables 90 may correspond to a show prop (e.g., animated character, vehicle, instrument) within the attraction portion 52. The guests 54 may be instructed to connect each of the one or more cables 90 to provide power to the corresponding show prop. The controller 64 may provide one or more visual and/or audio clues. For example, the controller 64 may instruct a first output device 62A (e.g., lamp) of the one or more output devices 62 to emit light to indicate the match to the connection pattern to the guests 54. In another example, the controller 64 may instruct a second output device 62B (e.g., speaker) of the one or more output devices 62 to output a song played by the instruments to indicate the match to the connection pattern to the guests 54. If the connections match the connection pattern, the controller 64 may instruct the one or more output devices 62 and/or the show prop to generate the show effect. For example, the show prop may activate and/or move as the show effect. As such, the show effect system 58 may provide entertainment to the guests 54.

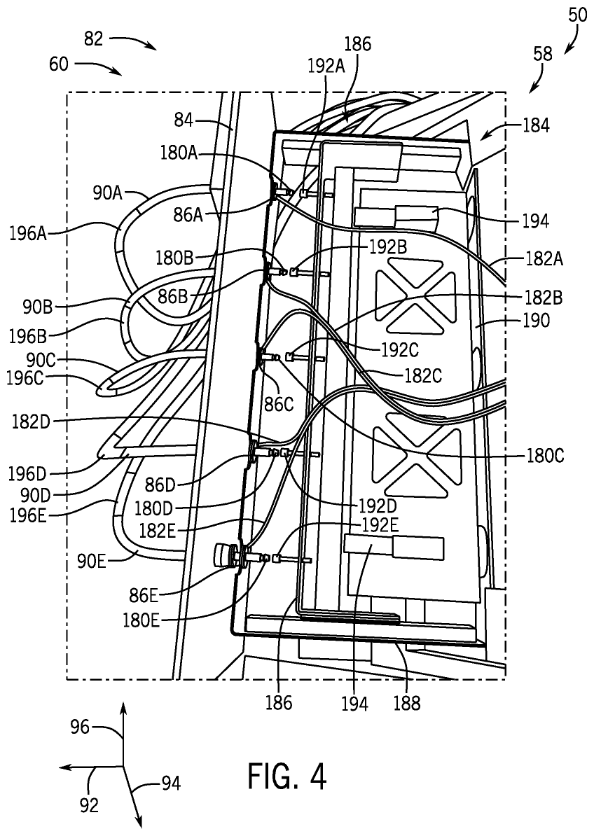

After the guest interactions, the show effect system 58 may transition from the coupled configuration 100A to a decoupled configuration 100B, as indicated by an arrow 102. For example, the show effect system 58 may be in the coupled configuration 100A due to guest interactions, and the controller 64 may instruct the show effect system 58 to reset for subsequent guest interactions without operator input. To transition from the coupled configuration 100A to the decoupled configuration 100B, the first volume 82 may include ejector components of the connector assembly 60 positioned within the enclosure 80. As further described with respect to FIG. 4, the ejector components may be positioned proximate to the one or more coupling joints 86 along the longitudinal direction 92, and adjusting the position and/or the orientation of the ejector components may disconnect the one or more cables 90 from the one or more coupling joints 86.

In the decoupled configuration 100B, the show effect system 58 may include the one or more cables 90 decoupled from (e.g., disconnected from) the one or more coupling joints 86. To this end, the controller 64 may instruct the ejector components to decouple the one or more cables 90 from the one or more coupling joints 86. For example, the one or more actuators may adjust the position and/or the orientation of the one or more pins in the longitudinal direction 92, thereby adjusting a position and/or orientation of the one or more cables 90 to decouple the one or more cables 90 from respective coupling joints 86. After the decoupling, the one or more cables 90 may be positioned proximate to one or both of the side panels 88. As such, the show effect system 58 may be reset for a subsequent group of the guests 54 and/or subsequent guest interactions. Additionally or alternatively, the controller 64 may instruct the one or more output devices 62 to stop generating the show effect. For example, the controller 64 may instruct the first output device 62A to stop emitting the light and/or the second output device 62B to stop outputting the sound. In this way, the show effect system 58 may be reset for subsequent guest interactions.

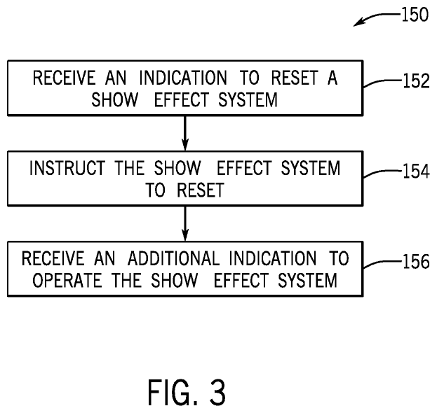

FIG. 3 is a flowchart of an embodiment of a process or method 150 for operating a show effect system (e.g., the show effect system 58) used in an attraction system (e.g., the attraction system 50). The method 150 includes various steps represented by blocks. It should be noted that the method 150 may be performed as an automated procedure by a control system, such as the controller 64 of FIG. 1. Although the flow chart illustrates the steps in a certain sequence, it should be understood that the steps may be performed in any suitable order and certain steps may be carried out simultaneously, where appropriate. Further, certain steps or portions of the method 150 may be performed by separate systems or devices.

At block 152, the controller receives an indication to reset a show effect system. For example, the controller may receive data from a guest tracking system indicative of guests leaving an attraction portion, guests preparing to enter the attraction portion, and/or guest presence within the attraction portion. In another example, an operator may provide the indication to reset the show effect system to the controller via an operator input device communicatively coupled to the controller. For example, the operator may use an input device, such as a knob, a switch, a button, a display, and/or the like, to provide the indication.

At block 154, the controller instructs the show effect system to reset. For example, the controller may instruct ejector components to eject one or more cables coupled to respective coupling joints. In certain instances, one actuator may adjust a position and/or an orientation of one pin such that the one pin contacts a particular cable of the one or more cables, thereby ejecting the particular cable from a respective coupling joint of the one or more coupling joints. In other instances, one or more actuators may adjust the position of a slidable plate, thereby adjusting the position and/or the orientation of multiple and/or all pins to eject multiple and/or all of the one or more cables from the respective coupling joints. Additionally or alternatively, the controller may instruct one or more output devices to stop generating show effects.

At block 156, the controller receives an additional indication to operate the show effect system. For example, the controller may receive data from the guest tracking system indicative of guests entering within the attraction portion with the show effect system. In another example, the controller may receive an indication indicative of operating the show effect system from the operator via one or more input devices. In response to receiving the indication, the controller may instruct the one or more output devices to generate visual and/or audio clues indicative of the connection pattern for the guests. In another example, the controller may monitor signals from the connector assembly to determine if the guest interactions match the connection pattern. If it is determined that the guest interactions match the connection pattern, then the show effect system may provide entertainment to the guests.

FIG. 4 is a top perspective view of an embodiment of the connector assembly 60 that may be used with and/or in the attraction system 50. In the illustrated example, the first volume 82 is depicted opened to show features of the ejector components. The show effect system 58 may be in the coupled configuration 100A (FIG. 2) with at least one cable of the one or more cables 90 coupled to a respective coupling joint 86. As discussed herein, each of the cables 90 may include a connector 180 (e.g., plug) that may be received by the respective coupling joint 86 to couple the components and generate a signal. For example, the first cable 90A may couple to the first coupling joint 86A via a first connector 180A, the second cable 90B may be coupled to the second coupling joint 96B via a second connector 180B, the third cable 90C may be coupled to the third coupling joint 86C via a third connector 180C, and so on.

In certain instances, the controller 64 (FIG. 2) may receive the signal from the one or more coupling joints 86 when coupled to a respective connector 180. For example, the one or more coupling joints 86 may each be coupled to and/or integrated with a sensor that generates sensor data indicative of the coupling. In another example, the one or more coupling joints 86 may generate an electrical signal in response to being coupled to a respective connector 180. The one or more coupling joints 86 may couple to one or more electrical cables 182 that may receive the signal (e.g., an electrical signal) from the respective coupling joint 86 and transmit the signal to the controller 64. For example, a first electrical cable 182A may be coupled to the first coupling joint 86A and transmit a signal from the first coupling joint 86A, a second electrical cable 182B may be coupled to the second coupling joint 86B and transmit a signal from the second coupling joint 86B, a third electrical cable 182C may be coupled to the third coupling joint 86C and transmit a signal from the third coupling joint 86C, a fourth electrical cable 182D may be coupled to the fourth coupling joint 86D and transmit a signal from the fourth coupling joint 86D, and a fifth electrical cable 182E may be coupled to the fifth coupling joint 86E and transmit a signal from the fifth coupling joint 86E. The controller 64 may use the signal(s) from the coupling joints 86 to determine if the connection of the connectors 180 and/or cables 90 by the guests match the connections of the connection pattern.

As discussed herein, the guest interactions include coupling each of the one or more cables 90 to a respective coupling joint 86. To eject the one or more cables 90, the connector assembly 60 may include ejection components that translate between a first position and a second position. The ejection components may include a support structure 184 with a slidable plate 186 coupled to one or more tracks 188 that enable movement of the slidable plate 186 relative to the front plate 84. As shown, the one or more tracks 188 include two tracks on opposite lateral sides of the slidable plate 186. The ejection components may also include a bottom portion 190, one or more pins 192 mounted (e.g., fixedly coupled) to the slidable plate 186, and one or more actuators 194 coupled to the slidable plate 186 and/or the bottom portion 190. The one or more tracks 188 may provide and/or support a sliding mechanism (e.g., bearings that travel along a slot) to enable linear translation of the slidable plate 186 toward and away from the front plate 84. The bottom portion 190 may provide support for the slidable plate 186, the one or more tracks 188, the one or more actuators 194, or any combination thereof.

In the illustrated example, the show effect system 58 may include a first pin 192A, a second pin 192B, a third pin 192C, a fourth pin 192D, and a fifth pin 192E that may be positioned proximate to a respective connector 180 of a respective cable 90 in the longitudinal direction 92. The one or more pins 192 may transition between a first position and a second position to decouple one or more connectors 180 from respective coupling joints 86. For example, the one or more actuators 194 may adjust the position and/or the orientation of the one or more pins 192 in the longitudinal direction 92 to eject the one or more connectors 180 from a respective coupling joint 86, thereby decoupling the one or more cables 90 from a respective coupling joint 86. In certain instances, the one or more pins 192 may be coupled to the slidable plate 186 and the one or more actuators 194 may adjust the position of the slidable plate 186 to simultaneously adjust the position and/or the orientation of the one or more pins 192 such that each of the pins 192 simultaneously (or substantially simultaneously) contacts a respective connector 180. For example, in a first position, the one or more pins 192 may not be in contact with the one or more connectors 180, while in a second position, the one or more pins 192 may be in contact with the one or more connectors 180. The one or more actuators 194 may continue to adjust the position and/or the orientation of the one or more pins 192 such that the one or more pins 192 push the one or more connectors 180 from the one or more coupling joints 86, thereby decoupling the one or more cables 90 and the one or more coupling joints 86.

In an embodiment, the one or more pins 192 may be movably coupled to the slidable plate 186. In such cases, the one or more actuators 194 may individually adjust the position and/or the orientation of one pin of the one or more pins 192 to disconnect a respective cable 90 of the one or more cables 90. For example, the controller 64 may receive the signal from the one or more electrical cables 182 and determine that a connection between a respective connector of the one or more connectors 180 and a respective coupling joint of the one or more coupling joints 86 does not match a connection of the connection pattern. The controller 64 may instruct one actuator of the one or more actuators 194 to eject the respective connector of the one or more connectors 180 by adjusting the position and/or the orientation of a respective pin 192. In this way, the show effect system 58 may provide a visual indication to the guest 54 of the connection not matching a connection of the connection pattern.

To facilitate guest interactions, the show effect system 58 may include a respective tag 196 (e.g., indicator, visual indicator, flag, sticker, label) on each of the one or more cables 90. For example, the first cable 90A may include a first tag 196A with one line, the second cable 90B may include a second tag 196B with two lines, the third cable 90C may include a third tag 196C with three lines, and so on. In other examples, the tag 196 may include a shape, a letter, a number, a color, and so on. The tags 196 may correspond to the visual and/or audio clues generated by the one or more output devices 62. For example, the one or more output devices 62 may generate a sound one time to indicate a connection between the first cable 90A and the first coupling joint 86A, generate a sound two times to indicate a connection between the second cable 90B and the second coupling joint 86B, and so on.

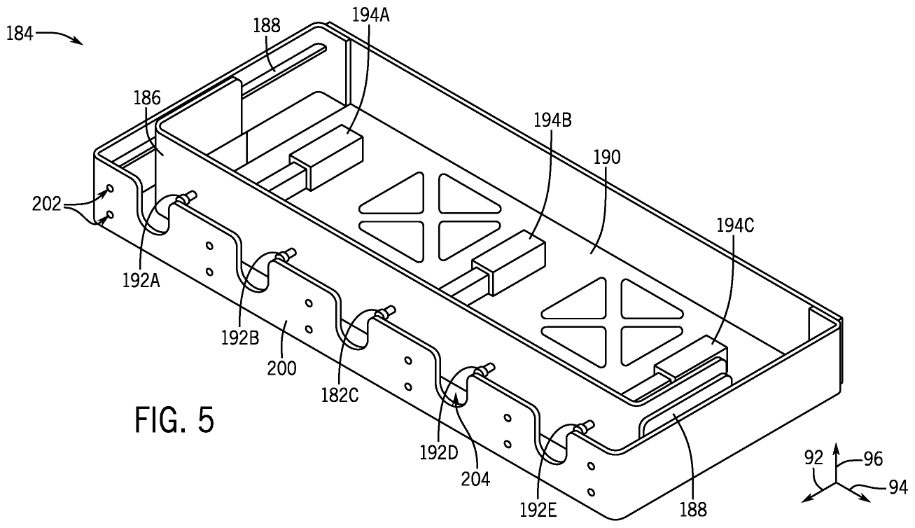

FIG. 5 is a perspective view of an embodiment of the connector assembly 60 (FIG. 2) that may be used in the attraction system 50 (FIG. 2). In particular, FIG. 5 illustrates the support structure 184, the one or more pins 192, and the one or more actuators 194. The support structure 184 may support and/or include the slidable plate 186 coupled to the one or more tracks 188 that provide movement of the slidable plate 186 and thereby to the one or more pins 192 to eject the one or more connectors 180 and/or the one or cables 90 (FIG. 2). For example, the one or more tracks 188 may each be a long guide rail for a side-mount ball-bearing carriage. The one or more actuators 194 may be coupled to the slidable plate 186 and the bottom portion 190, and the one or more actuators 194 may adjust the position of the slidable plate 186 between the first position and the second position relative to the bottom portion 190, thereby adjusting the position and/or the orientation of the one or more pins 192 between the first position and the second position relative to the bottom portion 190. The one or more actuators 194 may use linear motion, rotational motion, or a combination thereof. In certain instances, the one or more actuators 194 may each be a DC-powered linear actuator. In other instances, a first actuator 194A and a second actuator 194B may use linear motion and a third actuator 194C may use rotational motion. Alternating the types of motion used may improve precision, improve energy usage, and/or increase torque of the show effect system 58 (FIG. 2). The one or more actuators 194 may operate based on a position signal from the controller 64 (FIG. 2). For example, the one or more actuators 194 may receive a positive position signal (e.g., voltage) to adjust the position of the slidable plate 186 from the first position to the second position and receive a negative position signal to return the slidable plate 186 from the second position back to the first position. While the illustrated example includes three actuators 194 coupled to the bottom portion 190, any suitable number of actuators 194 may be used. For example, the connector assembly 60 may include one or more actuators, two or more actuators, four or more actuators, five or more actuators, and so on.

The support structure 184 may also include a connector plate 200 (e.g., mounting plate) with one or more holes 202 (e.g., through holes) to receive a respective fastener to mount the connector plate 200 to the front plate 84 (FIG. 2). As illustrated, the one or more holes 202 may be positioned between each of the one or more notches 204 along the lateral direction 94. The one or more holes 202 may each receive a fastener (e.g., a pin, a screw, a bolt) to mount (e.g., fixedly couple) the connector plate 200 to the front plate 84. Additionally or alternatively, the one or more holes 202 may receive a fastener to mount the connector plate 200 to any suitable material such as plywood, steel, metal, polymeric materials, and/or the like. It should be appreciated that the one or more holes 202 may be any suitable shape (e.g., key-slot interface; brackets) and/or size and the one or more holes 202 may be positioned at any suitable location on the connector plate 200 to mount the connector plate 200 to the front plate 84. As shown, the connector plate 200 may be integrally formed with or coupled to side plates (e.g., longitudinally-extending; laterally-facing) that support the one or more tracks 188.

The connector plate 200 may also include one or more notches 204 that may accommodate coupling by providing clearance and/or guidance for components within the show effect system 58. For example, the one or more notches 204 may provide space and/or clearance for a respective connector 180 to extend in the longitudinal direction 92. In another example, the one or more notches 204 may provide space for a respective pin 192 to transition between the first position and the second position to eject a respective connector 180. Additionally or alternatively, the notches 204 may align with a respective coupling joint 86 to reduce or eliminate electrical interference. In certain instances, the connector plate 200 may be made of a metal material. The one or more notches 204 may be a negative space within the connector plate 200 such that signal transmission to and/or from the one or more coupling joints 86 may be reduced or eliminated. For example, a size of each of the one or more notches 204 may be larger than a size of each of the coupling joints 86 to improve the electrical isolation between the connector plate 200 and the coupling joints 86.

The slidable plate 186 and the connector plate 200 may be positioned with a gap between the two components along the longitudinal direction 92. The gap may isolate the coupling joint 86 and/or the one or more electrical cables 182 from the one or more pins 192. Additionally or alternatively, the one or more electrical cables 182 may be grounded via a common ground to reduce and/or eliminate signal interference. Isolating the one or more coupling joints 86 and/or the one or more electrical cables 182 from the one or more pins 192 in this manner may reduce or eliminate interference to the signal and/or false determinations by the controller 64.

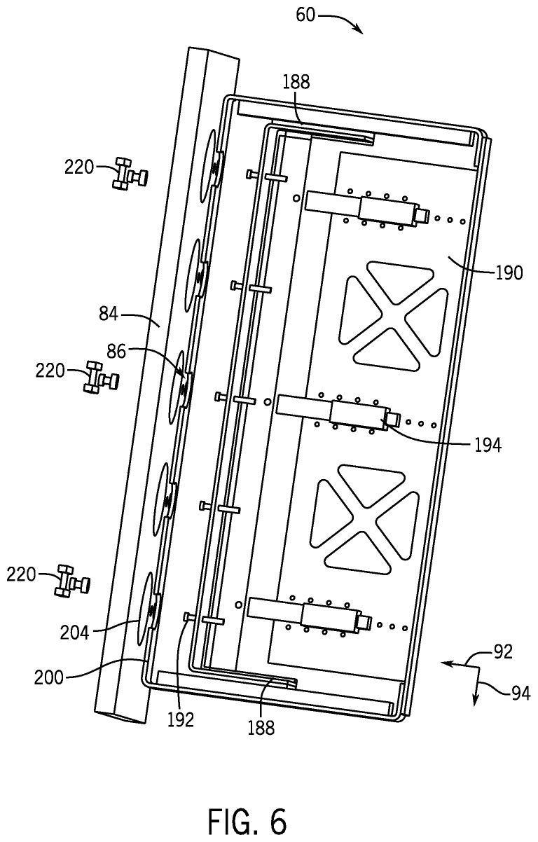

FIG. 6 is a partially exploded view of an embodiment of the connector assembly 60 that may be used with and/or in the attraction system 50 (FIG. 2). The connector assembly 60 of FIG. 6 is substantially similar to the connector assembly 60 of FIG. 5 except that the connector plate 200 as illustrated in FIG. 6 includes one or more bolts 220 for mounting the connector assembly 60 to the front plate 84. The one or more bolts 220 may include hex head bolts, u-bolts, stud bolts, and/or the like. For example, the one or more bolts 220 may couple the front plate 84 and the connector plate 200. The one or more bolts 220 may extend through the front plate 84 to the connector plate 200 to couple the front plate 84 to the connector plate 200. In certain instances, the one or more bolts 220 may be coupled to a surface of the connector plate 200 and through the connector plate 200 to couple to the front plate 84, which may obscure the one or more bolts 220 from the view of the guests 54. As such, the one or more bolts 220 may couple the front plate 84 to the connector plate 200. The one or more notches 204 may be oversized in comparison to the one or more coupling joints 86, which may make fastening the one or more bolts 220 easier for the operator. For example, the one or more bolts 220 may include one or more hex head bolts fastened using a wrench or socket.

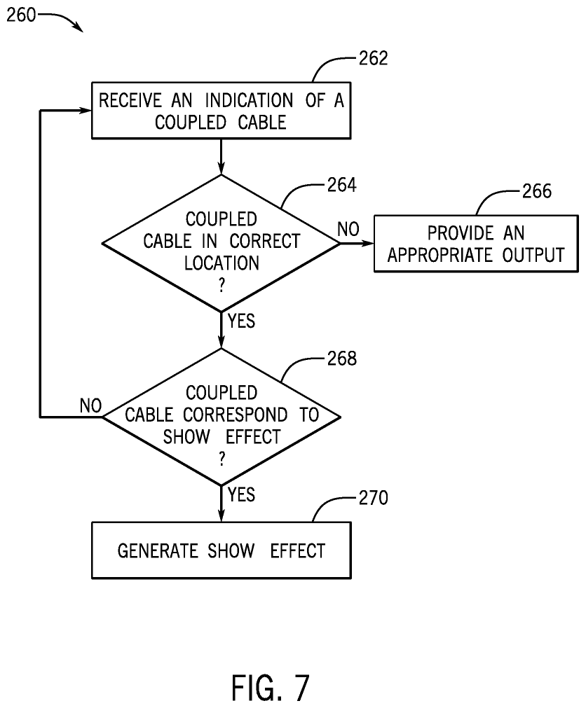

FIG. 7 is a flowchart of an embodiment of a process or method 260 for generating show effects via a show effect system (e.g., the show effect system 58) that may be used with and/or in an attraction system (e.g., the attraction system 50). The method 260 includes various steps represented by blocks. It should be noted that the method 260 may be performed as an automated procedure by a controller, such as the controller 64 of FIG. 1. Although the flowchart illustrates the steps in a certain sequence, it should be understood that the steps may be performed in any suitable order and certain steps may be carried out simultaneously, where appropriate. Further, certain steps or portions of the method 260 may be performed by separate systems or devices.

At block 262, the controller receives an indication of a coupled cable. For example, guests may couple a cable to a respective coupling joint via a connector of the cable. When coupled together, the cable and/or the coupling joint may transmit a signal to the controller indicative of coupling (e.g., connection). Additionally or alternatively, the guest tracking system may transmit data to the controller indicative of the guest interactions. For example, the guest tracking system may include one or more sensors to generate video data of the guest interactions within the attraction portion. The controller may receive the data and use image analysis techniques to identify a position of the coupled cable with respect to the show effect system and/or the position of a tag on the coupled cable. In certain instances, the controller may use the signal from the cable as a primary indication and the video data as a secondary indication to verify the primary indication.

At block 264, the controller determines if the connection between the coupled cable and the coupling joint matches a connection of a connection pattern (e.g., the coupled cable is in a correct location). For example, the controller may store a connection pattern with one or more target connections between the one or more cables and the one or more coupling joints. The controller may determine if the connection made by the guest of a cable and a respective coupling joint matches a connection of the connection pattern. For example, the controller may determine if the signal transmitted by the coupling joint matches a connection of the connection pattern. For example, the signal transmitted by the coupling joint may be a 1 if the connection matches a connection of the connection pattern and the signal may be a 0 if the connection does not match a connection of the connection pattern. In another example, the signal may be transmitted only if the connection matches a connection of the connection pattern. Additionally or alternatively, the connection pattern may include a visual pattern, such as a position and/or an orientation associated with each of the tags with respect to the one or more coupling joints and/or the show effect system. For example, the controller may receive image data from the guest tracking system indicative of a position and/or orientation of the tags within the attraction portion. The controller may use image analysis techniques to determine if the position and/or orientation of the tags within image data matches a visual pattern stored in the memory of the controller.

If the connection between the cable and the coupling joint does not match a connection of the connection pattern, then at block 266, the controller provides an appropriate output. For example, the controller may receive a signal indicative of 0, may not receive a signal, and/or may use image analysis techniques to determine that a position and/or orientation of a tag does not match the visual pattern. As such, the controller may provide a visual indication to the guests of the coupled cable being coupled to an incorrect coupling joint with respect to the connection pattern. For example, the controller may provide an appropriate output by instructing the ejection components to decouple the coupled cable from the respective coupling joint (e.g., after some period of time, such as 1, 2, 3, 4, 5, or more seconds of the coupled cable being coupled to an incorrect coupling joint). In another example, the controller may instruct one or more output devices to generate a visual and/or audio clue to indicate to the guests that the coupled cable is coupled to an incorrect coupling joint with respect to the connection pattern. For example, the one or more output devices may output a beeping sound as an audio clue and/or flashing lights as a visual clue. In this way, the show effect system may provide an indication of the incorrectly coupled cable.

If the connection between the cable and the coupling joint does match a connection of the connection pattern, then at block 268, the controller determines if the connection corresponds to providing (e.g., generating) a show effect. In certain instances, the controller may generate the show effect in response to all of connections between the cables and the coupling joints matching the connections of the connection pattern. As such, the controller may determine if the coupled cable completes the connection pattern. For example, the controller may determine if a quantity of coupled cables is equal to a total quantity of cables (e.g., all available or present cables for the show effect system). If the quantity of coupled cables is equal to the total quantity of cables, the controller may determine that the coupled cable corresponds to providing the show effect. If the quantity of coupled cables is less than the total quantity of cables, then the controller may determine that the coupled cable does not correspond to providing the show effect.

If the coupled cable corresponds to providing the show effect, then at block 230, the controller generates the show effect. For example, the controller may instruct the one or more output devices to generate the show effect, such as visual and/or audio effects for the guests.

If the coupled cable 90 does not correspond to providing the show effect, then the method 260 may return to block 262 to receive an indication of a coupled cable. The method 260 may then proceed to block 264 to determine if the coupled cable is in the correct location. If it is determined that the coupled cable is in the correct location, then the show effect system may provide an interactive experience for the guests.

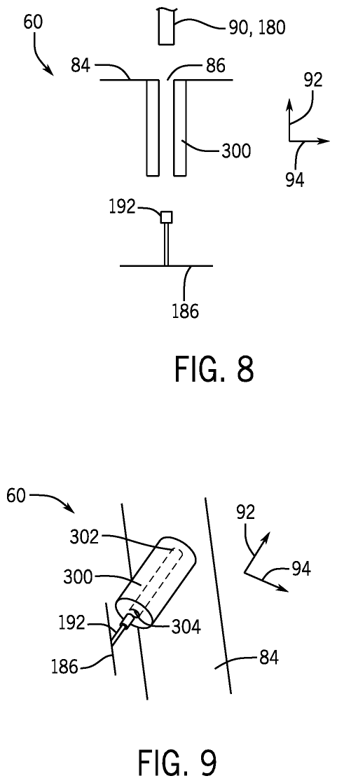

FIG. 8 is a top cross-sectional view of an embodiment of a portion of the connector assembly 60 that may be used in the show effect system 58. The connector assembly 60 may include a support structure 300 (e.g., annular support structure). In certain instances, repeated contact between a respective cable 90 and a respective pin 192 may cause wear and/or damage to the pin 192 over time, such as due to cyclic loading by repeatedly operating the show effect system 58. To support the pin 192, the support structure 300 may be coupled (e.g., mounted) to the front plate 84 and provide support to the pin 192 circumferentially about the pin 192 during contact with the cable 90. For example, the support structure 300 may be positioned proximate to a respective coupling joint 86 and extend in the longitudinal direction 92. The support structure 300 may include an opening to receive the pin 192 and the cable 90 in the longitudinal direction 92. For example, the cable 90 may be received by the coupling joint 86 and extend into the support structure 300 via the opening. Then, during the ejection of the cable 90, the pin 192 may travel in the longitudinal direction 92 and be received by the support structure 300 via the opening. The pin 192 may receive a forward force from the cable 90 during the contact and/or ejection of the cable 90 from the coupling joint 86. The support structure 300 may provide support to the pin 192 in the lateral direction 94, which may help distribute a longitudinal force during contact between the pin 192 and a connector 180, thereby reducing wear to the pin 192. The support structure 300 may also improve stability of the pin 192 by reducing radial movement of the pin 192, misalignment between the pin 192 and the cable 90, and/or shifting of the pin 192 during the contact and/or ejection of the cable 90 from the coupling joint 86.

In an embodiment, a portion (e.g., smaller length) of the pin 192 may be positioned within the support structure 300 while the pin 192 is in the first position and an additional portion (e.g., greater length) of the pin 192 may be positioned within the support structure 300 while the pin 192 is in the second position to contact the cable 90. For example, while the pin 192 is in the first position, a quarter of the pin 192 may be positioned within the support structure 300, half of the pin 192 may be positioned within the support structure 300, three-fourths of the pin 192 may be positioned within the support structure 300, and so on. Positioning the pin 192 within the support structure 300 may reduce the distance traveled by the pin 192 between the first position and the second position, which may reduce an amount of wear to the pin 192. Additionally or alternatively, positioning the pin 192 within the support structure 300 may reduce an amount of wear experienced by the pin 192 caused by repeatedly entering and leaving the support structure 300 via the opening.

FIG. 9 is a top perspective view of an embodiment of a portion of the connector assembly 60 that may be used within the show effect system 58. The connector assembly 60 may include the support structure 300. As shown, the support structure 300 may be configured to circumferentially surround the pin 192 to provide stability, reinforcement, and/or containment to the pin 192. As illustrated, the support structure 300 may be a circular ring that extends from the front plate 84 in the longitudinal direction 92 towards the pin 192. The support structure 300 may include a first opening 302 coupled to a respective coupling joint 86 and positioned to receive a respective cable 90. The support structure 300 may include a second opening 304 on an opposite end that may be positioned to receive a respective pin 192. During contact between the pin 192 and the cable 90, the support structure 300 may provide support to the pin 192, improve stability of the pin 192, reduce radial movement of the pin 192, reduce misalignment of the pin 192, and/or reduce shifting of the pin 192. Although the illustrated support structure 300 is cylindrical, the support structure 300 may be any suitable shape and/or size to provide support to the pin 192. For example, the support structure 300 may be rectangular, hexagonal, cubic, and/or the like. The support structure 300 may be implemented with all or some of the coupling joints 86 to provide support to one or more pins 192 (e.g., one holder with multiple openings for multiple pins 192; a respective holder for each of the one or more pins 192).

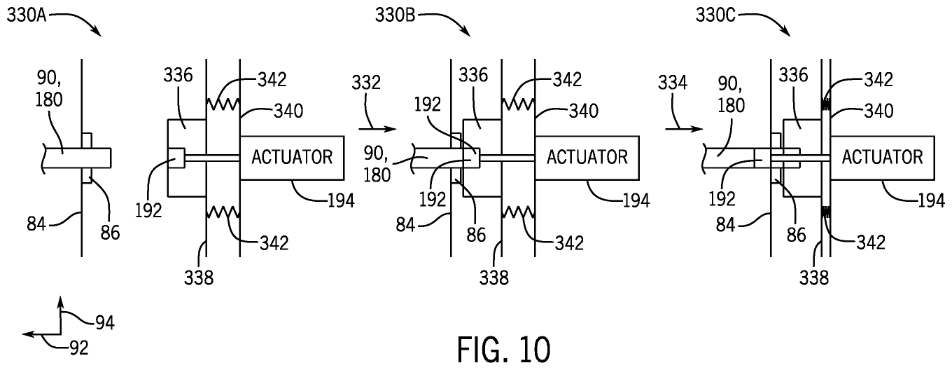

FIG. 10 is a schematic illustration of operating an embodiment of the connector assembly 60 (FIG. 2) that may be used with and/or in the attraction system 50 (FIG. 2). To provide support to the pin 192, the connector assembly 60 may include a support structure 336 that circumferentially surrounds and support the pin 192. The pin 192 may extend through the support structure 226 to contact the connector 180 of the cable 90. The support structure 336 is configured to extend about the pin 192 and provide a greater contact or force distribution area with the connector 180 of the cable 90 (e.g., as compared to the pin 192 alone), which may reduce stress and/or wear to the pin 192 by distributing the axial/longitudinal force across the increased contact or force distribution area.

In particular, FIG. 10 illustrates the connector assembly 60 ejecting a respective cable 90 by transitioning between a first configuration 330A, a second configuration 330B, and a third configuration 330C, as illustrated by arrows 332 and 334. The connector assembly 60 may also include a first plate 338 through which the pin 192 passes and to which the support structure 336 is coupled, a second plate 340 coupled to the pin 192 and an actuator 194, and one or more biasing members 342 (e.g., springs) coupled between the first plate 338 and the second plate 340. In the first configuration 330A, the connector assembly 60 may be in the coupled configuration. For example, the connector 180 of the cable 90 may be coupled to a respective coupling joint 86 in the first configuration 330A. To start transitioning between the configurations, the connector assembly 60 may move in a longitudinal direction 92 to position a respective pin 192 within the support structure 336 and proximate to the cable 90 in the longitudinal direction 92.

In the second configuration 330B, the pin 192 within the support structure 336 may move towards the coupling joint 86. In certain instances, the pin 192 and/or the support structure 336 may contact with the connector 180, the cable 90, and/or the coupling joint 86. For example, the actuator 194 may adjust the position and/or the orientation of the pin 192 in the longitudinal direction 92 until the pin 192 contacts with the connector 180 and/or the cable 90. As illustrated, the pin 192 is coupled with and/or supported by the support structure 336, which may reduce the amount of longitudinal force applied to the pin 192 by the connector 180 and/or the cable 90 during contact. To transition the pin 192 to the second configuration, the actuator 194 may adjust the position of the first plate 338 in the longitudinal direction 92. The first plate 338 may be movably coupled to the one or more side tracks 188 (FIGS. 4-6). and travel between the first configuration 330A and the second configuration 330B.

In the third configuration 330C, the pin 192 and/or the support structure 336 may decouple the connector 180 of the cable 90 from the coupling joint 86. For example, the actuator 194 may continue to adjust a position and/or an orientation of the second plate 340 in the longitudinal direction 92, thereby adjusting a position and/or an orientation of the pin 192 and/or the support structure 336 in the longitudinal direction 92 with the second plate 340 and eject the connector 180 of the cable 90 from the respective coupling joint 86. The actuator 194 may counteract and/or overcome a biasing force of the one or more biasing members 342 to decrease a distance between the first plate 338 and the second plate 340 to adjust the position and/or the orientation of the pin 192 relative to the support structure 336, such that the pin 192 protrudes from the support structure 336 to drive the connector 180 of the cable 90 from the respective coupling joint 86. In certain instances, the one or more side tracks 188 may include a stopper that stops the first plate 338 from traversing in the longitudinal direction 92. The actuator 194 may continue to adjust the position of the second plate 340 in the longitudinal direction 92 to by overcoming the biasing force. As such, the pin 192 may continue to move in the longitudinal direction 92 and decouple the connector 180 and/or the cable 90 from the respective coupling joint 86. In other instances, the first plate 338 may be stationary and the actuator 194 continues to adjust the position and/or the orientation of the pin 192 via the second plate 340. In this way, the connector assembly 60 may eject one or more pins 192 from a respective coupling joint 86.

The technical effects of the systems and methods described herein include controlling one or more actuators to eject one or more cables coupled to one or more coupling joints of a show effect system. During guest interactions, for example, the controller may determine that a connection between a cable and a coupling joint may not match a connection of a connection pattern and instruct the one or more actuators to decouple the cable from the coupling joint. The show effect system may provide a visual indication of the connection not matching a connection of the connection pattern. Additionally or alternatively, the controller may receive an indication to reset the show effect system for subsequent guest interactions. For example, the controller may receive data indicative of the guest position and instruct the one or more actuators to decouple all coupled cables from respective coupling joints for subsequent guest interactions. The show effect system may automatically reset for subsequent guest interactions without operator input. The show effect system may transition from a coupled configuration to a decoupled configuration to provide subsequent additional guest interactions. As such, the show effect system may reduce the amount of time used for resetting, thereby increasing the amount of time for guest interactions and/or guest throughput.

While only certain features of the subject matter have been illustrated and described herein, many modifications and changes will occur to those skilled in the art. It is, therefore, to be understood that the appended claims are intended to cover all such modifications and changes as fall within the true spirit of the disclosure. It should be appreciated that any features shown and described with reference to FIGS. 1-10 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A show effect system, comprising:
one or more cables;
a front panel coupled to a plurality of coupling joints configured to receive the one or more cables and provide a signal indicative of a connection between a first cable of the one or more cables and a first coupling joint of the plurality of coupling joints; and
a slidable plate coupled to a plurality of pins and an actuator, wherein the actuator is configured to drive the slidable plate to bring a first pin of the plurality of pins into contact with the first cable to disconnect the first cable from the first coupling joint.

2. The show effect system of claim 1, comprising a controller communicatively coupled to the plurality of coupling joints and the actuator, wherein the controller is configured to:
receive the signal indicative of the connection between the first cable and the first coupling joint; and
instruct the actuator to drive the slidable plate to bring the first pin into contact with the first cable to disconnect the first cable from the first coupling joint in response to determining the connection does not match a connection pattern.

3. The show effect system of claim 1, comprising a controller communicatively coupled to the plurality of coupling joints and the actuator, wherein the controller is configured to:
receive the signal indicative of the connection between the first cable and the first coupling joint; and
instruct an output device to generate a show effect in response to determining the connection matches a connection pattern.

4. The show effect system of claim 3, wherein the controller is configured to:
receive an additional signal indicative of an additional connection between a second cable of the one or more cables and a second coupling joint of the plurality of coupling joints; and
instruct the output device to generate the show effect in response to determining the connection and the additional connection match the connection pattern.

5. The show effect system of claim 3, wherein the controller is configured to instruct the output device to generate a visual clue or an audio clue based on the connection pattern.

6. The show effect system of claim 3, wherein the controller is configured to:
instruct the output device to generate the show effect in response to determining the connection matches the connection pattern and a quantity of the one or more cables coupled to the plurality of coupling joints matches a total quantity of the one or more cables.

7. The show effect system of claim 1, wherein the slidable plate comprises a first slidable plate coupled to a plurality of support structures configured to circumferentially support the plurality of pins, a second slidable plate coupled to the plurality of pins and the actuator, and a biasing member between the first slidable plate and the second slidable plate, wherein the actuator is configured to drive the second slidable plate to bring the first pin into contact with the first cable.

8. The show effect system of claim 1, comprising a support structure coupled to the front panel and positioned proximate to the first coupling joint, wherein the support structure is configured to circumferentially surround the first pin while the first pin is in contact with the first cable.

9. The show effect system of claim 1, comprising:
a guest tracking system configured to provide sensor data indicative of a guest position of one or more guests; and
a controller configured to:
determine the guest position of the one or more guests based on the sensor data; and
instruct the actuator to drive the slidable plate to bring the first pin into contact with the first cable to disconnect the first cable from the first coupling joint based on the guest position of the one or more guests.

10. The show effect system of claim 9, wherein the controller is configured to instruct the actuator to drive the slidable plate to bring the first pin into contact with the first cable to disconnect the first cable from the first coupling joint in response to determining the guest position indicates that none of the one or more guests are in a vicinity of the one or more cables and the front panel coupled to the plurality of coupling joints.

11. A connector assembly, comprising:
a slidable plate coupled to a plurality of pins;
a mounting plate configured to couple to a front panel of a show effect system, wherein the front panel comprises a plurality of coupling joints configured to receive a plurality of cables; and
an actuator configured to drive the slidable plate relative to the mounting plate from a first position to a second position to cause the plurality of pins to contact and eject the plurality of cables received by the plurality of coupling joints.

12. The connector assembly of claim 11, comprising one or more support structures coupled to and extending from the mounting plate and configured to support the plurality of pins.

13. The connector assembly of claim 11, comprising side tracks positioned on opposite lateral sides of the mounting plate and configured to slidingly support the slidable plate.

14. The connector assembly of claim 11, wherein the actuator comprises a linear actuator.

15. The connector assembly of claim 11, wherein the plurality of pins is spaced apart from one another along a lateral axis of the connector assembly.

16. A show effect system, comprising:
a guest tracking system configured to generate data indicative of a guest position;
one or more cables;
one or more coupling joints, wherein each coupling joint of the one or more coupling joints is configured to receive a respective cable of the one or more cables and provide a respective signal indicative of a respective connection to the respective cable of the one or more cables;
one or more pins configured to contact the one or more cables to disconnect the one or more cables from the one or more coupling joints;
an actuator configured to adjust the one or more pins from a first position to a second position to cause the one or more pins to contact the one or more cables to disconnect of the one or more cables from the one or more coupling joints; and
a controller communicatively coupled to the guest tracking system, the one or more coupling joints, and the actuator, wherein the controller is configured to:
receive the data indicative of the guest position; and
instruct the actuator to adjust the one or more pins from the first position to the second position based on the guest position.

17. The show effect system of claim 16, comprising a slidable plate coupled to the one or more pins and the actuator, wherein the actuator is configured to drive the slidable plate to adjust a position of the one or more pins.

18. The show effect system of claim 16, comprising an output device configured to generate an audio effect, a visual effect, or both, wherein the controller is configured to:
instruct the output device to generate the audio effect, the visual effect, or both based on a connection pattern for the one or more cables and the one or more coupling joints.

19. The show effect system of claim 18, wherein the controller is configured to:
receive one or more signals indicative of one or more connections between the one or more coupling joints and the one or more cables; and
instruct the output device to generate the audio effect, the visual effect, or both in response to determining that the one or more connections match the connection pattern.

20. The show effect system of claim 19, wherein the controller is configured to:
instruct the actuator to adjust the one or more pins from the first position to the second position in response to determining that the one or more connections do not match the connection pattern.
